(19) United States
(12) Patent Application Publication
(10) Pub. No.: US 2026/0147111 A1
(43) Pub. Date: May 28, 2026

(54) GROUND PENETRATING RADAR (GPR) DETECTION IMAGING METHOD AND DEVICE FOR DEVELOPMENT CONDITION OF FROZEN WALL, AND PROCESSING EQUIPMENT

(71) Applicant: Wuhan University, Wuhan (CN)

(72) Inventors: Diansen YANG, Wuhan (CN); Xinhao YU, Wuhan (CN); Weiming LIANG, Wuhan (CN); Zhixiang WANG, Wuhan (CN); Junwei XU, Wuhan (CN)

(73) Assignee: Wuhan University, Wuhan (CN)

(21) Appl. No.: 19/296,583

(22) Filed: Aug. 11, 2025

(30) Foreign Application Priority Data
Nov. 27, 2024 (CN) 2024117119011

(51) Int. Cl. G01S 13/88; G01S 13/89; G06T 5/70; G06T 11/00

(52) U.S. Cl. CPC G01S 13/885; G01S 13/89; G06T 5/70; G06T 11/00

(57) ABSTRACT

The present disclosure provides a Ground Penetrating Radar (GPR) detection imaging method and device for a development condition of a frozen wall, and processing equipment. The method is used to additionally consider the correlation between signals of each channel based on the signals collected by GPR detection, and realize secondary imaging through a cross-correlation back projection method to avoid interference caused by complex conditions of an electromagnetic interference detection environment such as shield segments. This can effectively improve the resolution and imaging accuracy, help to more clearly complete the identification of the development condition of the frozen wall, and meet a high-quality data usage requirement of rock engineering involving Artificial Ground Freezing method (AGF).

### CROSS-REFERENCE TO RELATED APPLICATIONS

The application claims priority to Chinese patent application No. 2024117119011, filed on Nov. 27, 2024, the entire contents of which are incorporated herein by reference.

### TECHNICAL FIELD

The present disclosure relates to the field of geology, and in particular, to a Ground Penetrating Radar (GPR) detection imaging method and device for a development condition of a frozen wall, and processing equipment.

### BACKGROUND

The Artificial Ground Freezing method (AGF) refers to transformation of natural rock and soil into frozen soil under the action of low temperature to form a frozen wall by using the artificial refrigeration technology, so as to temporarily isolate groundwater, which is an important construction method for crossing complex strata. Due to its advantages such as good waterproof effect, strong adaptability, and green environmental protection, it has been widely used in different underground projects.

In actual geotechnical engineering projects, adverse geological conditions such as excessive groundwater flow rate, water-rich cemented rock strata, gravel strata, local underground cavities, and excessively high soil salt content often occur. Under these conditions, the frozen wall often fails to close on time, the overall strength of the frozen wall does not meet the standards, or there are cavities in the wall, which not only causes significant economic losses, but also greatly threatens the construction safety. Therefore, the development condition of the frozen wall directly determines the success or failure of the freezing project. The early prediction, process detection and effect evaluation of abnormal development conditions of the frozen wall are particularly important.

In traditional solutions, the development condition of the frozen wall is usually judged based on temperature measurement data, and the expansion and thickness of the frozen wall are roughly inferred through experience. However, due to the limited location and number of temperature measurement points, it is impossible to accurately describe the overall development condition of the frozen area, which may easily lead to misjudgment and omission of some unfrozen areas.

The principle of Ground Penetrating Radar (GPR) is to use the reflection and transmission of ultra-high frequency electromagnetic waves (1 MHz-5 GHz) to determine the distribution inside the medium. The dielectric constant and the conductivity are the two most critical factors affecting the detection effect of GPR. The greater the difference in electromagnetic parameters between the media is, the more obvious the reflection and deflection of the electromagnetic waves will be, and the two media will be easier to detect and identify. GPR plays an increasingly important role in near-surface exploration. The physical and electrical properties of natural frozen soil and unfrozen soil are extremely different. Therefore, as long as GPR detection is carried out on the frozen rock and soil at a reasonable location and the data is analyzed and compared, the distribution area of the abnormal frozen wall and the development condition of the frozen wall can be explored.

However, the inventors of the present disclosure have found that there are still problems in the existing solution of identifying the development solution of the frozen wall through GPR detection. Specifically, due to the complexity of the detection environment, such as the electromagnetic interference of shield segments, the frozen wall is usually adjacent to the segment area, and the electromagnetic waves need to pass through the segment layer to reach the target soil layer, which will affect the accurate judgment of the detection image results, resulting in limitations to the recognition accuracy and efficiency of the development condition of the frozen wall.

### SUMMARY

The present disclosure provides a Ground Penetrating Radar (GPR) detection imaging method and device for a development condition of a frozen wall, and processing equipment. The method is used to additionally consider the correlation between signals of each channel based on the signals collected by GPR detection, and realize secondary imaging through a cross-correlation back projection method to avoid interference caused by complex conditions of an electromagnetic interference detection environment such as shield segments. This can effectively improve the resolution and imaging accuracy, help to more clearly complete the identification of the development condition of the frozen wall, and meet a high-quality data usage requirement of rock engineering involving Artificial Ground Freezing method (AGF).

In a first aspect, the present disclosure provides a GPR detection imaging method for a development condition of a frozen wall, including:
acquiring a first signal obtained by GPR detection processing of a frozen rock and soil body to be detected, where the frozen rock and soil body to be detected is processed by Artificial Ground Freezing method (AGF) to form a corresponding frozen wall;
performing data preprocessing on the first signal to obtain a second signal to preliminarily enhance a signal quality;
based on the second signal, in a process of imaging processing by using the back projection method, considering a correlation between signals of each channel, and achieving secondary imaging by using a cross-correlation back projection method to obtain a reconstructed image; and
performing secondary signal processing on the reconstructed image to obtain a third signal to further enhance the signal quality.

In a second aspect, the present disclosure provides a GPR detection imaging device for a development condition of a frozen wall, including:
an acquisition unit, configured to acquire a first signal obtained by GPR detection processing of a frozen rock and soil body to be detected, where the frozen rock and soil body to be detected is processed by Artificial Ground Freezing method (AGF) to form a corresponding frozen wall;
a preprocessing unit, configured to perform data preprocessing on the first signal to obtain a second signal to preliminarily enhance a signal quality;
an imaging unit, configured to, based on the second signal, in a process of imaging processing by using the back projection method, consider a correlation between signals of each channel, and achieve secondary imaging by using a cross-correlation back projection method to obtain a reconstructed image; and
a secondary processing unit, configured to perform secondary signal processing on the reconstructed image to obtain a third signal to further enhance the signal quality.

In a third aspect, the present disclosure provides a processing device, including a processor and a memory, where a computer program is stored in the memory, and the processor executes the method provided in the first aspect of the present disclosure or the method provided in any one possible implementation in the first aspect of the present disclosure when calling the computer program in the memory.

In a fourth aspect, the present disclosure provides a computer-readable storage medium, where the computer-readable storage medium stores a plurality of instructions, the instructions suitable for being loaded by a processor to execute the method provided in the first aspect of the present disclosure or the method provided in any one possible implementation in the first aspect of the present disclosure.

It can be concluded from the above content that the present disclosure has the following beneficial effects:

For the GPR detection imaging target of the development condition of the frozen wall, the present disclosure, based on the signals collected by GPR detection, additionally considers the correlation between the signals of each channel, and realizes secondary imaging through the cross-correlation back projection method to avoid the interference caused by the complex conditions of an electromagnetic interference detection environment such as shield segments. This can effectively improve the resolution and imaging accuracy, help to more clearly complete the identification of the development condition of the frozen wall, and meet a high-quality data usage requirement of rock engineering involving AGF.

### BRIEF DESCRIPTION OF DRAWINGS

In order to more clearly illustrate the technical solutions in the embodiments of the present disclosure, the drawings required for use in the description of the embodiments will be briefly introduced below. Apparently, the drawings described below are only some embodiments of the present disclosure. For those skilled in the art, other drawings can be obtained based on these drawings without creative labor.

FIG. 1 is a schematic diagram of a process of a GPR detection imaging method for a development condition of a frozen wall in the present disclosure;

FIG. 2 is a schematic diagram of a scenario of a movement from a frozen area to an unfrozen area for GPR detection in the present disclosure;

FIG. 3 is a schematic structural diagram of a GPR detection imaging device for a development condition of a frozen wall in the present disclosure; and

FIG. 4 is a schematic diagram of a structure of processing equipment of the present disclosure.

### DETAILED DESCRIPTION OF THE EMBODIMENTS

The technical solutions in the embodiments of the present disclosure will be clearly and completely described below in conjunction with the drawings in the embodiments of the present disclosure. Apparently, the described embodiments are only part of the embodiments of the present disclosure, rather than all of the embodiments. Based on the embodiments in the present disclosure, all other embodiments obtained by those skilled in the art without exerting any creative labor shall fall within the scope of protection of the present disclosure.

The terms “first”, “second”, and the like in the specification and claims of the present disclosure and the above drawings are used to distinguish similar objects and are not necessarily used to describe a specific order or sequence. It is to be understood that the terms so used are interchangeable under appropriate circumstances such that the embodiments described herein are capable of being practiced in sequences other than those illustrated or described herein. In addition, the terms “include” and “have”, and any variations thereof are intended to cover non-exclusive inclusions. For example, a process, method, system, product, or apparatus that includes a series of steps or modules is not necessarily limited to those steps or modules explicitly listed, but may include other steps or modules not explicitly listed or inherent to these processes, methods, products, or apparatuses. The naming or numbering of the steps in the present disclosure does not mean that the steps in the method flow must be executed in the time/logical sequence indicated by the naming or numbering. The named or numbered process steps can change the execution order according to the technical purpose to be achieved, as long as the same or similar technical effects can be achieved.

The division of modules appearing in the present disclosure is a logical division. There may be other division methods when implemented in actual applications. For example, multiple modules can be combined or integrated into another system, or some features can be ignored or not executed. In addition, the mutual coupling or direct coupling or communication connection shown or discussed may be through some interfaces, and the indirect coupling or communication connection between modules may be electrical or other similar forms, which are not limited in this disclosure. Furthermore, the modules or sub-modules described as separate components may or may not be physically separated, may or may not be physical modules, or may be distributed in multiple circuit modules, and some or all of the modules may be selected according to actual needs to achieve the purpose of the present disclosure.

Before introducing the GPR detection imaging method for a development condition of a frozen wall provided by the present disclosure, the background content involved in the present disclosure is first introduced.

The GPR detection imaging method and device for a development condition of a frozen wall, and computer-readable storage medium provided in the present disclosure can be applied to processing equipment to additionally consider the correlation between the signals of each channel based on the signals collected by GPR detection, and realize secondary imaging through a cross-correlation back projection method to avoid interference caused by complex conditions of an electromagnetic interference detection environment such as shield segments, which can effectively improve the resolution and imaging accuracy, help to more clearly complete the identification of the development condition of the frozen wall, and meet a high-quality data usage requirement of rock engineering involving AGF.

For the GPR detection imaging method for a development condition of a frozen wall mentioned in the present disclosure, the executing body may be processing equipment of different types such as the GPR detection imaging device for a development of a frozen wall, or a server integrated with the GPR detection imaging device for a development of a frozen wall, a physical host, or user equipment (UE). The GPR detection imaging device for a development condition of a frozen wall can be implemented in hardware or software. The UE can specifically be a terminal device such as a smart phone, a tablet computer, a laptop computer, a desktop computer or a personal digital assistant (PDA), and the processing device can be set in the form of a device cluster.

It can be understood that, in actual situations, considering that the present disclosure is usually data processing based on the existing data obtained by GPR detection processing, the processing equipment that executes the GPR detection imaging method for a development of a frozen wall of the present disclosure, or the processing equipment equipped with the corresponding application service of the GPR detection imaging method for a development of a frozen wall of the present disclosure, usually only needs to meet the required data processing capabilities. If it involves GPR detection data acquisition and processing, or the output/display of image results, it is apparent that the specific equipment structure and equipment deployment form of the processing equipment can be further adaptively adjusted according to the actual situation.

As an example, the processing equipment of the present disclosure under an equipment cluster solution may specifically include GPR equipment responsible for data collection on site, central processing equipment responsible for data processing in the background, and display equipment responsible for image display on a user side, corresponding to the three major aspects that may be involved when applying the solution of the present disclosure, thus having a relatively complete solution deployment feature.

Next, the GPR detection imaging method for a development of a frozen wall provided by the present disclosure is introduced.

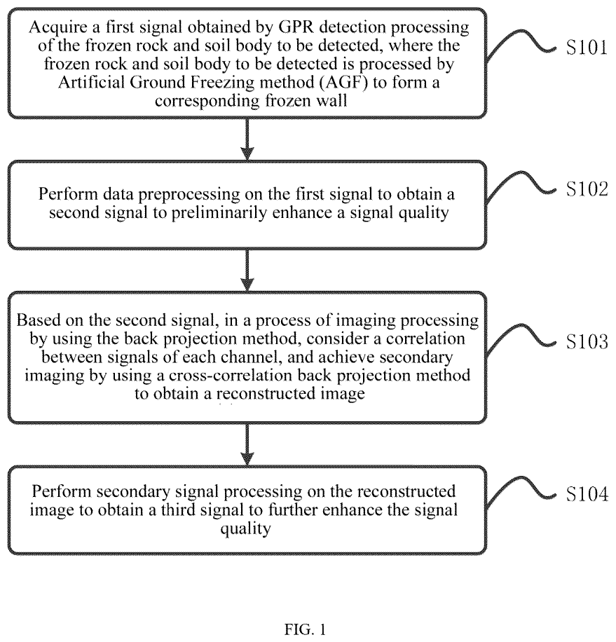

First, refer to FIG. 1, FIG. 1 shows a schematic flow chart of a GPR detection imaging method for a development condition of a frozen wall in the present disclosure. The GPR detection imaging method for a development of a frozen wall provided in the present disclosure may specifically include the following steps S101 to S104:

Step S101, GPR detection processing is performed on a frozen rock and soil body to be detected to obtain a first signal, where the frozen rock and soil body to be detected is processed by AGF to form a corresponding frozen wall.

It can be understood that in engineering work, the application of AGF may be involved, which transforms natural rock and soil into frozen soil under the action of low temperature to form a frozen wall by usings the artificial refrigeration technology, so as to temporarily isolate groundwater. In this regard, there is a corresponding demand for frozen wall monitoring to ensure that the project can be carried out under the expected conditions.

In this regard, as in the prior art, after AGF processing, GPR (geological radar) detection processing can be carried out on the frozen rock and soil to be detected on site to obtain the original signal for subsequent data processing. For the convenience of explanation, the original signal obtained here is recorded as the first signal, and subsequent signals will also be distinguished by the second signal and the third signal.

It should be noted that the acquisition processing of the first signal here can be either real-time signal acquisition processing, that is, involving real-time GPR detection processing, or extraction processing of ready-made signals, that is, directly extracting the detection results of the completed GPR detection processing, which can be adjusted according to actual needs.

As an exemplary embodiment here, the GPR detection processing involved in the present disclosure may specifically include the following processing contents:
after radar selection, survey line layout, and detection environment optimization, the specific detection work begins. The GPR host machine remains close to the surface of the segment and moves forward in a straight line at a uniform speed along the survey line. The speed is no higher than 5 cm/s and remains consistent. The distance moved along the survey line is consistent each time and the error does not exceed 5 cm. The detection time node starts before freezing and is guaranteed to be detected once every 6 hours during an active freezing period, and each survey line is detected 3 times each time.

Therefore,
(1) For radar selection, the target detection depth can be determined based on the thickness and strength of the frozen wall design in the freezing project, combined with the design size of the segment, so as to determine the center frequency of the GPR equipment (that is, geological radar). Usually, 400-1200 MHz can be selected to take into account both the target depth and resolution of detection.
(2) For the survey line layout, the distribution and length of the survey lines can be reasonably planned and arranged in combination with the location and estimated thickness of the frozen wall to ensure that the subsequent detection data can fully reflect the development condition of the frozen area.
(3) For the optimization of the detection environment, specifically, in order to improve the imaging quality and prevent misjudgment or missed detection results, on the one hand, due to the shielding property of metal conductors on electromagnetic waves, it is necessary to reduce their electromagnetic interference as much as possible. The construction environment of the freezing site can be cleaned up, such as temporarily removing unnecessary scaffolding and steel pipes near the survey line to ensure that there are no large loading equipment around when the detection work is carried out. On the other hand, in order to make the detection results as concise and clear as possible and avoid the appearance of complex multi-layer media, when conducting detection work, the insulation layer of the segment can be temporarily removed while ensuring that the overall freezing effect is not affected, and then rearranged after the detection work is completed.
(4) For specific detection work, when detection work is performed, the GPR host machine (transmitting/receiving antenna) can be kept close to the surface of the segment and move forward in the straight line at the uniform speed along the direction of the survey line. The speed is not higher than 5 cm/s and is always consistent. The distance moved along the survey line is consistent each time and the error does not exceed 5 cm; the detection time node starts before freezing, and detection is guaranteed every 6 hours during an active freezing period. Each measuring line is detected 3 times each time to ensure the reliability and stability of the data.

Regarding the specific detection solution here, it is worth noting that in conventional GPR detection processing, when the interface between different media is detected, the interface between adjacent media is usually parallel to the survey line layout direction. In the freezing project, the target medium changes along the detection direction, which has an adverse effect on the resolution and accuracy of the detection. In contrast, the specific detection solution given in the present disclosure can effectively avoid this problem and ensure the subsequent high level of imaging accuracy and resolution, so it has better practical value.

Step S102, data preprocessing is performed on the first signal to obtain a second signal to preliminarily enhance a signal quality;
after the first signal is acquired, the present disclosure does not directly carry out the corresponding imaging processing, but also involves the operation of data preprocessing to enhance the signal quality. This setting helps to improve the processing efficiency and processing accuracy of subsequent imaging processing.

It can be understood that data preprocessing is a common part of data analysis work. The specific preprocessing operations involved can usually adopt existing solutions, or further optimize and improve the existing solutions, or adopt self-developed novel solutions. These are all allowed in actual situations.

In this way, after the data preprocessing is completed to obtain the second signal, specific imaging processing can be carried out.

As an exemplary embodiment here, the data preprocessing involved in the present disclosure can specifically include the removal of data points with abnormal noise, the removal of data points with lost content, time zero point correction, background noise removal, and gain processing.

Specifically,
(1) For the removal of data points with abnormal noise, apparently, its purpose is to remove/filter out data points with abnormal noise, that is, abnormal noise points, which is one of the more traditional data preprocessing operations.
(2) For the removal of data points with content loss, apparently, its purpose is to remove/filter out data points with content loss, i.e., content loss points, which is one of the more traditional data preprocessing operations.
(3) Time zero correction processing, which takes into account that the echo signals may not be on the correct time axis due to the relative position of the transmitting and receiving antennas, so the time zero point/time axis of the data can be corrected.
(4) Background noise removal, which takes into account the noise of the antenna system itself that may exist in the data. Therefore, background noise can be removed by background averaging or filtering.
(5) Gain processing, which considers that the signal will attenuate when penetrating the medium, and increasing the gain can improve the visibility of the later reflected signal. Specifically, time-varying gain or exponential gain can be used to enhance the signal.

In this way, through the above data preprocessing operations, the differences between frozen soil and unfrozen soil can be further highlighted in specific applications, which helps to improve the subsequent imaging quality.

Step S103, based on the second signal, in the process of imaging processing using the back projection method, a correlation between the signals of each channel is considered, and secondary imaging is achieved by using the cross-correlation back projection method to obtain a reconstructed image;

in the imaging process, back projection processing is involved. It is understandable that back projection processing itself is a processing link also involved in the prior art. However, the inventors of the present disclosure have found that the back projection processing or back projection method adopted by the existing solution only considers the combination (accumulated result) of the response amplitude (vector form) of each channel as the final imaging result, but does not consider the inherent correlation in the vector, so there are limitations to imaging accuracy and resolution.

In this case, the imaging processing involved in the present disclosure, in the process of performing imaging processing through the back projection method, additionally considers/pays attention to the correlation between the signals of each channel, and calculates the combined results of the response amplitudes through a specially designed cross-correlation back projection method as a new imaging result output to obtain improved imaging accuracy and resolution.

The output data of the imaging processing here is itself also a signal and can be recorded as a reconstructed image.

Next, the imaging process here may be understood more deeply in combination with the GPR detection process.

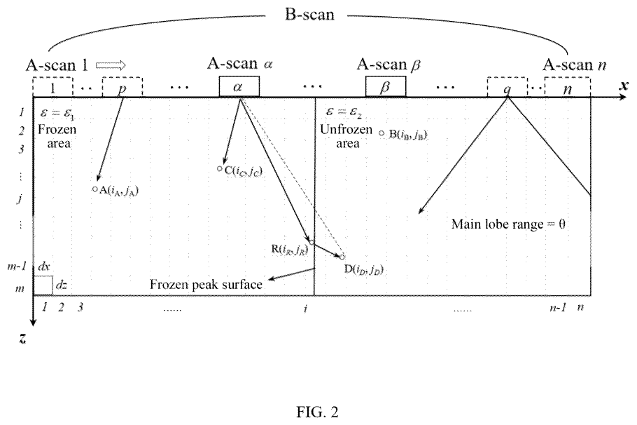

Referring to FIG. 2, it shows a schematic diagram of a scenario of a movement from a frozen area to an unfrozen area for GPR detection in the present disclosure, and in the detection process, the following contents may be involved in the detection process:

the designated detection area is divided into m×n pixels, each pixel has a width of dₓ and a height of d_{z}, thus forming a plane model with the frozen area on the left and the unfrozen area on the right. Started from x=0, the radar moves forward, continuously emitting and receiving electromagnetic waves.

Corresponding to a limited working range of a GPR main lobe, the detection scanning process can be divided into four different stages:
1) phase I: The frozen area below is detected, characterized by a single medium, a stable response amplitude (RA), and no deflection;
2) phase II: At a boundary where the main lobe range intersects the unfrozen area, the response amplitude is stratified, resulting in the deflection;
3) phase III: The main lobe signal contains both the frozen area and the unfrozen area, indicating that the scanning coverage gradually transitions to the unfrozen area; and
4) phase IV: the unfrozen area below is detected to complete the comprehensive scanning process.

GPR has three scanning modes, corresponding to which three types of data can be obtained, namely A-scan data (single-channel waveform data), B-scan data (two-dimensional profile data), and C-scan data (three-dimensional data).

As an exemplary embodiment, the back projection method involved above may specifically include the following contents:
it is assumed that the designated detection area is divided into m×n pixels, the two-way travel time (TWT) τ_{A,P} of pixel A in the p^{th} channel signal of the A-scan data can be expressed as follows:

$${τ}_{A , p} = \frac{2 \sqrt{{ε}_{1} \cdot [ {( {x}_{p} - ( {i}_{A} \cdot {d}_{x} ) )}^{2} + {( {j}_{A} \cdot {d}_{z} )}^{2}}}{c} ,$$

where ε1 is a relative dielectric constant of the frozen soil area, dimensionless, dₓ is a pixel width, d_{z} is a pixel height, c is a propagation speed of light in vacuum, i_{A} is an abscissa of the pixel A, and j_{A} is an ordinate of the pixel A,
in this case, the response amplitude RA_{A,P} corresponding to each pixel can be expressed as follows:

$${RA}_{A , p} = {s}_{p} ( t = {τ}_{A , p} ) ,$$

where Sₚ is a reflected electromagnetic wave recorded by the GPR moving to the p^{th} channel signal,
then, considering that the transmitted radar signal has a main lobe characteristic, if a certain pixel (for example, pixel B) is located outside the main lobe of the A-scan, the value of the response amplitude may appear to be zero. In general, the response amplitude of a pixel in phase I can be expressed as follows:

$$\{ \begin{matrix}{RA}_{A , p} = {s}_{p} ( t = {τ}_{A , p} ) , ϕ \leq \frac{θ}{2} \\ 0 , ϕ > \frac{θ}{2} \\ ϕ = arc tan ( \vert \frac{{x}_{p} - ( {i}_{A} \cdot {d}_{x} )}{{j}_{A} \cdot {d}_{z}} \vert )\end{matrix} ,$$

where θ is a maximum coverage distance of a radar main lobe signal,
when the GPR enters the phases II and III, the signal is refracted due to the change of the medium along the measurement line. For example, for a pixel D, the round-trip propagation time of the pixel D in A-scan can be expressed as follows:

$${τ}_{D , α} = \frac{2 ( \sqrt{{ε}_{1} \cdot [ {( {x}_{α} - ( {i}_{R} \cdot {d}_{x} ) )}^{2} + {( {j}_{R} \cdot {d}_{z} )}^{2} ]} + \sqrt{{ε}_{2} \cdot [ {( ( {i}_{D} - {i}_{R} ) \cdot {d}_{x} )}^{2} + {( ( {j}_{D} - {j}_{R} ) \cdot {d}_{z} )}^{2} ]} )}{c} ,$$

where ε₂ is a relative dielectric constant of the unfrozen soil area, dimensionless;
the electromagnetic wave is emitted from the αth synthetic aperture position, passes through the refraction point R(i_{R},j_{R}) according to Snell's refraction law to reach point D(i_{D},j_{D}), and then reaches the GPR antenna for reception. The coordinates of the refraction point R(i_{R},j_{R}) can be determined by an iterative method. When the electromagnetic wave enters the unfrozen area, the response amplitude of the pixel can be described as follows:

$$\{ \begin{matrix}{RA}_{D , α} = {s}_{α} ( t = {τ}_{D , α} ) , ϕ \leq \frac{θ}{2} \\ 0 , ϕ > \frac{θ}{2} \\ ϕ = arc tan ( \vert \frac{{x}_{α} - ( {i}_{D} \cdot {d}_{x} )}{{j}_{D} \cdot {d}_{z}} \vert )\end{matrix} ,$$

the GPR measurement generates n sets of A-scan data, as shown in FIG. 2, and the response of each imaging point in the signal is distributed in the n sets of A-scan data generated by the GPR measurement. For example, for a given point A, i.e., corresponding pixel A, at least n two-way propagation times have to be calculated. These TWT data are used to index and retrieve the information corresponding to the point A in the corresponding A-scan data, thereby generating an n×1 vector representing point A, i.e., [RA_{A,1}, RA_{A,2}, . . . . RA_{A,n}],
in this case, the standard back projection method has n groups of response amplitudes corresponding to the pixel A (n here corresponds to n in the previous m×n pixels, that is, the same specific value), and the vectors are combined into an imaging output result, as shown in the following formula:

$${E}_{A} = {\sum }_{k = 1}^{n} {RA}_{A , k} ,$$

however, the inventors of the present disclosure have found that the existing back projection method (BP) only combines these n vectors to obtain the final imaging result, but does not consider the correlation between the various A-scan signals, which limits the imaging accuracy and resolution.

In this regard, in order to emphasize the intrinsic correlation between the acquired vectors, the present disclosure improves the back projection method and implements it by constructing a correlation matrix V.

Specifically, as an exemplary embodiment here, the correlation between the signals (A-scan signals) can be specifically represented by the correlation matrix V constructed by the following formula:

$${V}_{( i \times j )} = ( \begin{matrix}{RA}_{A , 1} \cdot {RA}_{A , 2} , & {RA}_{A , 1} \cdot {RA}_{A , 3} & … & {RA}_{A , 1} \cdot {RA}_{A , n - 1} , & {RA}_{A , 1} \cdot {RA}_{A , n} \\ 0 & {RA}_{A , 2} \cdot {RA}_{A , 3} & … & {RA}_{A , 2} \cdot {RA}_{A , n - 1} , & {RA}_{A , 2} \cdot {RA}_{A , n} \\ ⋮ & ⋮ & … & ⋮ & ⋮ \\ 0 & 0 & … & {RA}_{A , n - 2} \cdot {RA}_{A , n - 1} , & {RA}_{A , n - 2} \cdot {RA}_{A , n} \\ 0 & 0 & … & 0 & {RA}_{A , n - 1} \cdot {RA}_{A , n}\end{matrix} ) ,$$

in this way, through the cross-correlation operation, the amount of calculation is increased from n to n× (n−1)/2, and the correlation superposition process can be expressed as follows:

$${E}_{A}^{C B P} = {\sum }_{i = 1}^{n - 1} {\sum }_{j = i + 1}^{n} R {A}_{A , i} \cdot {RA}_{A , j} ,$$

where E_{A}^{CBP} is the sum of the response amplitudes calculated by the cross-correlation back projection method, and i and j are the row and column numbers of the current element in the correlation matrix v, respectively.

It can be seen that the present disclosure performs cross-correlation back projection based on the designed correlation matrix V, and obtains the E_{A}^{CBP} that takes into account the correlation between the signals, and realizes the calculation of the response amplitude of the pixel A with higher accuracy and more in line with the deep-level situation, so that as a whole, it can balance the imaging accuracy and resolution.

Specifically, the imaging processing involved in the present disclosure, or the improved back projection method involved, can clearly image, suppress most of the clutter interference, avoid the interference caused by the complex conditions of the electromagnetic interference detection environment such as shield segments, and effectively improve the imaging accuracy and resolution. Secondly, for the unconventional stratified medium model of the vertical freezing front, it can also better image the position of the boundary of the frozen soil and the unfrozen soil and the development morphology of the frozen wall, improve the readability of the detection results, and more intuitively highlight the stratified areas and abnormal areas.

Step S104, secondary signal processing is performed on the reconstructed image to obtain a third signal to further enhance the signal quality.

It can be understood that after the imaging processing of the second signal is completed, further data enhancement can be continued on the reconstructed image. It can be understood that the data enhancement processing here is recorded as secondary processing, and the specific strategies/rules involved in the specific data enhancement operation are different from those of the previous data preprocessing. It is necessary to consider not only the data characteristics of the input data as the reconstructed image obtained after the previous imaging processing, but also the input requirements involved in the subsequent data analysis work, rather than staying at the level of broadly improving data quality as conventionally understood.

Further, as an exemplary embodiment here, the signal secondary processing involved in the present disclosure may specifically include filtering processing and data enhancement processing; filtering processing includes high-pass filtering, low-pass filtering, band-pass filtering, and direct wave removal;
data enhancement processing includes frequency domain conversion, elimination of random noise through convolution operations, and comparison of data at different time points.

In the filtering processing, specifically:
(1) For high-pass filtering and low-pass filtering, the appropriate cutoff frequency is pre-selected according to the characteristics of the data to remove high-frequency noise and low-frequency drift in the data;
(2) For bandpass filtering, to retain the effective signals within a specific frequency band, the noise is further reduced;
(3) As for removal of direct waves, to consider that direct waves may mask important reflected signals, especially in near-surface detection, differential filtering and other methods can be used to remove the direct waves.

It can be understood that the above-mentioned filtering processing means is a relatively common filtering method in signal filtering processing, which is integrated with the data enhancement means to achieve the effect of effectively and better realizing the secondary enhancement of the signal. In the data enhancement process, specifically,
(1) For frequency domain conversion, it is aimed at frequency analysis. Through methods such as Fourier transform, the signal is converted into the frequency domain to enhance the signal characteristics and facilitate signal analysis.
(2) For elimination of random noise through convolution operation, it is to further eliminate the random noise in the signal through convolution operation;
(3) Data at different time points is compared, which can also be referred to as differential processing. For the evaluation of the freezing effect, the time difference method can be used to compare data at different time points, thereby highlighting the changes in the frozen area more conveniently and intuitively.

In general, it can be seen from the above solution that for the GPR detection and imaging target of the development of the frozen wall, the present disclosure, based on the signals collected by GPR detection, additionally considers the correlation between signals of each channel, and realizes secondary imaging through the cross-correlation back projection method to avoid the interference caused by the complex conditions of the electromagnetic interference detection environment such as shield segments. This can effectively improve the resolution and imaging accuracy, help to more clearly complete the identification of the development condition of the frozen wall, and meet a high-quality data usage requirement of rock engineering involving AGF.

After the imaging processing and secondary signal processing are completed, it can be understood that it can be used in the specific data application link, the most important of which is apparently the identification, analysis, and processing of the development condition of the frozen wall.

In this regard, as an exemplary embodiment, after secondary signal processing is performed on the reconstructed image in step S104 to obtain a third signal to further enhance the signal quality, the method of the present disclosure may further include:
based on the third signal, further data analysis and processing are carried out;
data analysis and processing include reflection signal analysis, identification of the development of the frozen wall, and differential imaging, specifically as follows:
(1) The reflection signal analysis specifically includes: changes in a medium before and after freezing are analyzed according to signal characteristics including intensity and phase changes, where the strong reflection area corresponds to a frozen area or abnormal structure;
(2) The frozen wall development condition identification specifically includes: based on the relationship between reflection time and velocity, a thickness of the frozen wall and an abnormal development area of the frozen wall are calculated, and detection imaging results are verified by combining a temperature measurement inversion temperature field method; and
(3) The differential imaging specifically includes: background subtraction processing is performed on the radar data before and after freezing to eliminate unchanged background signals.

It can be understood that in this embodiment here, in addition to the identification of the development of the frozen wall based on the high-precision third signal obtained previously, it may also involve the identification of frozen areas/abnormal structures, and further background removal based on the frozen areas. In this way, in terms of details, it provides specific practical solutions from three aspects for the data application that may be involved in the present disclosure. It can provide high-quality data support for different types of underground engineering projects such as mines, deep mountains, emergency rescue or municipal subways, which will help to advance underground engineering projects more safely, stably and efficiently, and therefore has better practical value.

It is to be understood that for the three aspects of data analysis operations here, in actual applications, the existing solutions may be used, or further optimizations and improvements may be made on the basis of the existing solutions, or novel self-developed solutions may also be used. These are all possible and can be configured according to the actual user needs.

The above is the introduction to the GPR detection imaging method for a development condition of a frozen wall provided by the present disclosure. In order to better implement the GPR detection imaging method for a development condition of a frozen wall provided by the present disclosure, the present disclosure also provides a GPR detection imaging device for a development condition of a frozen wall from the perspective of functional modules.

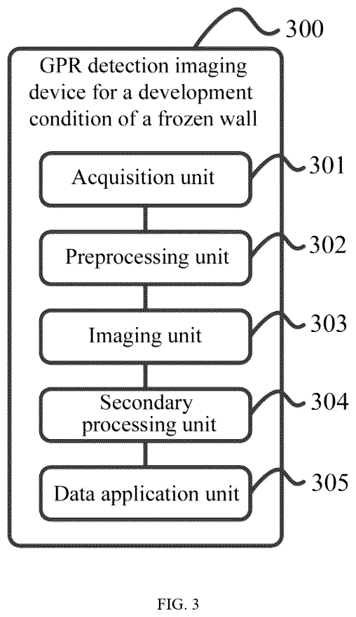

Referring to FIG. 3, FIG. 3 is a schematic structural diagram of a GPR detection imaging device for a development condition of a frozen wall in the present disclosure. In the present disclosure, the GPR detection imaging device 300 for a development condition of a frozen wall may specifically include the following structure:
an acquisition unit 301, configured to acquire a first signal obtained by GPR detection processing of a frozen rock and soil body to be detected, where the frozen rock and soil body to be detected is processed by Artificial Ground Freezing method (AGF) to form a corresponding frozen wall;
a preprocessing unit 302, configured to perform data preprocessing on the first signal to obtain a second signal to preliminarily enhance a signal quality;
an imaging unit 303, configured to, based on the second signal, in a process of imaging processing by using the back projection method, consider a correlation between signals of each channel, and achieve secondary imaging by using a cross-correlation back projection method to obtain a reconstructed image; and
a secondary processing unit 304, configured to perform secondary signal processing on the reconstructed image to obtain a third signal to further enhance the signal quality.

As an exemplary embodiment, the back projection method includes the following contents:
it is assumed that a designated detection area is divided into m×n pixels, and a round-trip propagation time τ_{A,P} of a pixel A in the p^{th} channel signal of A-scan data is expressed as follows:

$${τ}_{A , p} = \frac{2 \sqrt{{ε}_{1} \cdot [ {( {x}_{p} - ( {i}_{A} \cdot {d}_{x} ) )}^{2} + {( {j}_{A} \cdot {d}_{z} )}^{2} ]}}{c} ,$$

where ε₁ is a relative dielectric constant of a frozen soil area, dₓ is a pixel width, d_{z} is a pixel height, c is a propagation speed of light in vacuum, i_{A} is an abscissa of the pixel A, and j_{A} is an ordinate of the pixel A,
a response amplitude RA_{A,P} corresponding to each pixel is expressed as follows:

$$R {A}_{A , p} = {s}_{p} ( t = {τ}_{A , p} ) ,$$

where Sₚ is a reflected electromagnetic wave recorded by the GPR moving to the p^{th} channel signal,
the response of each imaging point in the signal is distributed in n groups of A-scan data generated by GPR measurement, and corresponding to the pixel A, there are n groups of response amplitudes, and a vector combination is an imaging output result, which is expressed as follows:

$$R {A}_{A , p} = {s}_{p} ( t = {τ}_{A , p} ) .$$

As another exemplary embodiment, the correlation between the signals of each channel is represented by a correlation matrix V constructed by the following formula:

$${V}_{( i \times j )} = ( \begin{matrix}{RA}_{A , 1} \cdot {RA}_{A , 2} , & {RA}_{A , 1} \cdot {RA}_{A , 3} & … & {RA}_{A , 1} \cdot {RA}_{A , n - 1} , & {RA}_{A , 1} \cdot {RA}_{A , n} \\ 0 & {RA}_{A , 2} \cdot {RA}_{A , 3} & … & {RA}_{A , 2} \cdot {RA}_{A , n - 1} , & {RA}_{A , 2} \cdot {RA}_{A , n} \\ ⋮ & ⋮ & … & ⋮ & ⋮ \\ 0 & 0 & … & {RA}_{A , n - 2} \cdot {RA}_{A , n - 1} , & {RA}_{A , n - 2} \cdot {RA}_{A , n} \\ 0 & 0 & … & 0 & {RA}_{A , n - 1} \cdot {RA}_{A , n}\end{matrix} ) ,$$

a relevant superposition process is expressed as follows:

$${E}_{A}^{C B P} = {\sum }_{i = 1}^{n - 1} {\sum }_{j = i + 1}^{n} R {A}_{A , i} \cdot {RA}_{A , j} ,$$

where E_{A}^{CBP} is the sum of the response amplitudes calculated by the cross-correlation back projection method, and i and j are the row number and column number of the current element in the correlation matrix v, respectively.

As another exemplary embodiment, the GPR detection process includes the following processing contents:
after radar selection, survey line layout, and detection environment optimization, specific detection work is began, where a GPR host machine remains close to a surface of a segment and moves forward in a straight line at a uniform speed along the survey line; the speed is no higher than 5 cm/s and remains consistent; a distance moved along the survey line is consistent each time and an error does not exceed 5 cm; and a detection time node starts before freezing and is guaranteed to be detected once every 6 hours during an active freezing period, and each survey line is detected 3 times each time.

As another exemplary embodiment, data preprocessing includes removal processing of data points with abnormal noise, removal processing of data points with content loss, time zero point correction processing, background noise removal processing, and gain processing.

As another exemplary embodiment, the signal secondary processing includes filtering processing and data enhancement processing;
the filtering processing includes high-pass filtering, low-pass filtering, band-pass filtering, and direct wave removal; and
the data enhancement process includes frequency domain conversion, elimination of random noise by convolution operation, and comparison of data at different time points.

As another exemplary embodiment, the device further includes an application unit 305, configured to:
based on the third signal, carry out further data analysis and processing,
where the data analysis and processing includes reflection signal analysis, frozen wall development condition identification, and differential imaging;
the reflection signal analysis specifically includes: changes in a medium before and after freezing is analyzed according to signal characteristics including intensity and phase changes, where the strong reflection area corresponds to a frozen area or abnormal structure;
the frozen wall development condition identification specifically includes: based on the relationship between reflection time and velocity, a thickness of the frozen wall and an abnormal development area of the frozen wall are calculated, and detection imaging results are verified by combining a temperature measurement inversion temperature field method; and
the differential imaging specifically includes: background subtraction processing is performed on the radar data before and after freezing to eliminate unchanged background signals.

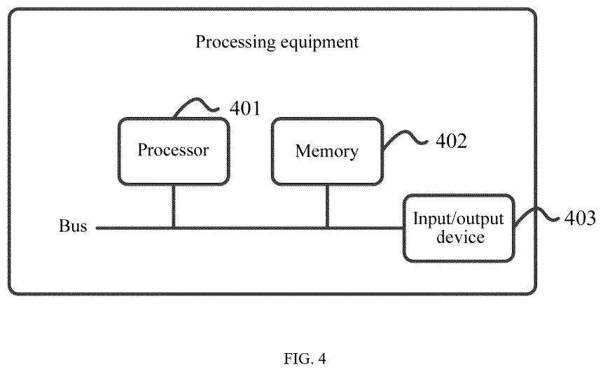

The present disclosure also provides a processing device from the perspective of hardware structure. Referring to FIG. 4, FIG. 4 shows a schematic structural diagram of the processing device of the present disclosure. Specifically, the processing device of the present disclosure may include a processor 401, a memory 402, and an input/output device 403. The processor 401 is configured to implement the steps of the GPR detection imaging method for a development condition of a frozen wall in the embodiment corresponding to FIG. 1 when executing the computer program stored in the memory 402; alternatively, the processor 401 is configured to execute the computer program stored in the memory 402 to implement the functions of each unit in the corresponding embodiment of FIG. 3, and the memory 402 is configured to store the computer program required for the processor 401 to execute the GPR detection imaging method for a development condition of a frozen wall in the corresponding embodiment of FIG. 1 above.

Exemplarily, the computer program may be divided into one or more modules/units, one or more modules/units are stored in the memory 402 and executed by the processor 401 to complete the present disclosure. One or more modules/units may be a series of computer program instruction segments capable of performing specific functions, and the instruction segments are configured to describe the execution process of the computer program in a computer device.

The processing device may include, but is not limited to, a processor 401, a memory 402, and an input/output device 403. Those skilled in the art may understand that the diagram is merely an example of a processing device and does not constitute a limitation to the processing device. The device may include more or fewer components than shown in the diagram, or a combination of certain components, or different components. For example, the processing device may also include a network access device, a bus, and the like. The processor 401, the memory 402, the input/output devices 403, and the like are connected via a bus.

The processor 401 may be a central processing unit (CPU), or another general-purpose processor, a digital signal processor (DSP), an application-specific integrated circuit (ASIC), a field-programmable gate array (FPGA), or another programmable logic device, a discrete gate or transistor logic device, a discrete hardware component, or the like. A general purpose processor may be a microprocessor or any conventional processor, or the like. The processor is the control center of the processing device and connects various parts of the entire device using various interfaces and lines.

The memory 402 may be configured to store computer programs and/or modules. The processor 401 implements various functions of the computer device by running or executing the computer programs and/or modules stored in the memory 402 and calling the data stored in the memory 402. The memory 402 may mainly include a program storage area and a data storage area, where the program storage area may store an operating system, an application program required for at least one function, and the like; the storage data area may store data created according to the use of the processing device, and the like. In addition, the memory may include a high-speed random access memory and may also include a non-volatile memory, such as a hard disk, a memory, a plug-in hard disk, a Smart Media Card (SMC), a Secure Digital (SD) card, a Flash Card, at least one disk storage device, a flash memory device, or another volatile solid-state storage device.

When configured to execute the computer program stored in the memory 402, the processor 401 may specifically implement the following functions:
acquiring a first signal obtained by GPR detection processing of the frozen rock and soil body to be detected, where the frozen rock and soil body to be detected is processed by Artificial Ground Freezing method (AGF) to form a corresponding frozen wall;
performing data preprocessing on the first signal to obtain a second signal to preliminarily enhance a signal quality;
based on the second signal, in a process of imaging processing by using the back projection method, considering a correlation between signals of each channel, and achieving secondary imaging by using a cross-correlation back projection method to obtain a reconstructed image; and
performing secondary signal processing on the reconstructed image to obtain a third signal to further enhance the signal quality.

Those skilled in the art may clearly understand that, for the convenience and brevity of description, the specific working process of the GPR detection imaging device for a development condition of a frozen wall, the processing equipment, and corresponding units described above may refer to the description of the GPR detection imaging method for a development condition of a frozen wall in the corresponding embodiment of FIG. 1, and the details will not be repeated here.

Those of ordinary skill in the art may understand that all or part of the steps in the various methods of the above embodiments may be completed by instructions, or by controlling related hardware through instructions. The instructions may be stored in a computer-readable storage medium and loaded and executed by a processor.

To this end, the present disclosure provides a computer-readable storage medium storing a plurality of instructions, which can be loaded by a processor to execute the steps of the GPR detection imaging method for a development condition of a frozen wall in the embodiment corresponding to FIG. 1 of the present disclosure. Specific operations may refer to the description of the GPR detection imaging method for a development condition of a frozen wall in the embodiment corresponding to FIG. 1, which will not be repeated here.

The computer-readable storage medium may include: Read Only Memory (ROM), Random Access Memory (RAM), disk or CD, and the like.

Since the instructions stored in the computer-readable storage medium may execute the steps of the GPR detection imaging method for a development condition of a frozen wall in the embodiment corresponding to FIG. 1 of the present disclosure, the beneficial effects that can be achieved by the GPR detection imaging method for a development condition of a frozen wall in the embodiment corresponding to FIG. 1 of the present disclosure can be achieved, which refer to the previous description and will not be repeated here.

The GPR detection imaging method and device for a development condition of a frozen wall, processing equipment, and a computer-readable storage medium provided by the present disclosure are described in detail above. The principle and implementation method of the present disclosure are described in detail using specific examples. The description of the above embodiments is only used to help understand the method and core idea of the present disclosure. At the same time, for those skilled in the art, according to the concept of the present disclosure, there will be changes in the specific implementation methods and application scopes. In summary, the content of this specification should not be understood as limiting the present disclosure.

What is claimed is:

1. A Ground Penetrating Radar (GPR) detection imaging method for a development condition of a frozen wall, comprising:
acquiring a first signal obtained by GPR detection processing of a frozen rock and soil body to be detected, wherein the frozen rock and soil body to be detected is processed by Artificial Ground Freezing method (AGF) to form a corresponding frozen wall;
performing data preprocessing on the first signal to obtain a second signal to preliminarily enhance a signal quality;
based on the second signal, in a process of imaging processing by using the back projection method, considering a correlation between signals of each channel, and achieving secondary imaging by using a cross-correlation back projection method to obtain a reconstructed image; and
performing secondary signal processing on the reconstructed image to obtain a third signal to further enhance the signal quality, wherein
the back projection method comprises the following contents:
assuming that a designated detection area is divided into m×n pixels, and a round-trip propagation time τ_{A,P} of a pixel A in the p^{th} channel signal of A-scan data is expressed as follows:
$${τ}_{A , p} = \frac{2 \sqrt{{ε}_{1} \cdot [ {( {x}_{p} - ( {i}_{A} \cdot {d}_{x} ) )}^{2} + {( {j}_{A} \cdot {d}_{z} )}^{2} ]}}{c} ,$$
wherein ε₁ is a relative dielectric constant of a frozen soil area, dₓ is a pixel width, d_{z} is a pixel height, c is a propagation speed of light in vacuum, i_{A} is an abscissa of the pixel A, and j_{A} is an ordinate of the pixel A,
a response amplitude RA_{A,P} corresponding to each pixel is expressed as follows:
$$R {A}_{A , p} = {s}_{p} ( t = {τ}_{A , p} ) ,$$
wherein Sₚ is a reflected electromagnetic wave recorded by the GPR moving to the p^{th} channel signal,
the response of each imaging point in the signal is distributed in n groups of A-scan data generated by GPR measurement, and corresponding to the pixel A, there are n groups of response amplitudes, and a vector combination is an imaging output result, which is expressed as follows:
$${E}_{A} = {\sum }_{k = 1}^{n} R {A}_{A , k} .$$

2. The method according to claim 1, wherein the correlation between the signals of each channel is represented by a correlation matrix V constructed by the following formula:
$${V}_{( i \times j )} = ( \begin{matrix}{RA}_{A , 1} \cdot {RA}_{A , 2} , & {RA}_{A , 1} \cdot {RA}_{A , 3} & … & {RA}_{A , 1} \cdot {RA}_{A , n - 1} , & {RA}_{A , 1} \cdot {RA}_{A , n} \\ 0 & {RA}_{A , 2} \cdot {RA}_{A , 3} & … & {RA}_{A , 2} \cdot {RA}_{A , n - 1} , & {RA}_{A , 2} \cdot {RA}_{A , n} \\ ⋮ & ⋮ & … & ⋮ & ⋮ \\ 0 & 0 & … & {RA}_{A , n - 2} \cdot {RA}_{A , n - 1} , & {RA}_{A , n - 2} \cdot {RA}_{A , n} \\ 0 & 0 & … & 0 & {RA}_{A , n - 1} \cdot {RA}_{A , n}\end{matrix} ) ,$$
a relevant superposition process is expressed as follows:
$${E}_{A}^{C B P} = {\sum }_{i = 1}^{n - 1} {\sum }_{j = i + 1}^{n} R {A}_{A , i} \cdot {RA}_{A , j} ,$$
wherein E_{A}^{CBP} is the sum of the response amplitudes calculated by the cross-correlation back projection method, and i and j are the row number and column number of the current element in the correlation matrix v, respectively.

3. The method according to claim 1, wherein the GPR detection process comprises the following processing contents:
after radar selection, survey line layout, and detection environment optimization, beginning specific detection work, wherein a GPR host machine remains close to a surface of a segment and moves forward in a straight line at a uniform speed along the survey line; the speed is no higher than 5 cm/s and remains consistent; a distance moved along the survey line is consistent each time and an error does not exceed 5 cm; and a detection time node starts before freezing and is guaranteed to be detected once every 6 hours during an active freezing period, and each survey line is detected 3 times each time.

4. The method according to claim 1, wherein the data preprocessing comprises removal processing of data points with abnormal noise, removal processing of data points with content loss, time zero point correction processing, background noise removal processing, and gain processing.

5. The method according to claim 1, wherein the secondary signal processing comprises filtering processing and data enhancement processing;
the filtering processing comprises high-pass filtering, low-pass filtering, band-pass filtering, and direct wave removal; and
the data enhancement process comprises frequency domain conversion, elimination of random noise by convolution operation, and comparison of data at different time points.

6. The method according to claim 1, wherein after performing secondary signal processing on the reconstructed image to obtain a third signal to further enhance the signal quality, the method further comprises:
based on the third signal, further carrying out data analysis and processing;
wherein the data analysis and processing comprises reflection signal analysis, frozen wall development condition identification, and differential imaging;
the reflection signal analysis specifically comprises: analyzing changes in a medium before and after freezing according to signal characteristics comprising intensity and phase changes, wherein the strong reflection area corresponds to a frozen area or abnormal structure;
the frozen wall development condition identification specifically comprises: based on the relationship between reflection time and velocity, calculating a thickness of the frozen wall and an abnormal development area of the frozen wall, and verifying detection imaging results by combining a temperature measurement inversion temperature field method; and
the differential imaging specifically comprises: performing background subtraction processing on the radar data before and after freezing to eliminate unchanged background signals.

7. A Ground Penetrating Radar (GPR) detection imaging device for a development condition of a frozen wall, comprising:
an acquisition unit, configured to acquire a first signal obtained by GPR detection processing of a frozen rock and soil body to be detected, wherein the frozen rock and soil body to be detected is processed by Artificial Ground Freezing method (AGF) to form a corresponding frozen wall;
a preprocessing unit, configured to perform data preprocessing on the first signal to obtain a second signal to preliminarily enhance a signal quality;
an imaging unit, configured to, based on the second signal, in a process of imaging processing by using the back projection method, consider a correlation between signals of each channel, and achieve secondary imaging by using a cross-correlation back projection method to obtain a reconstructed image; and
a secondary processing unit, configured to perform secondary signal processing on the reconstructed image to obtain a third signal to further enhance the signal quality, wherein
the back projection method comprises the following contents:
assuming that a designated detection area is divided into m×n pixels, and a round-trip propagation time τ_{A,P} of a pixel A in the p^{th} channel signal of A-scan data is expressed as follows:
$${τ}_{A , p} = \frac{2 \sqrt{{ε}_{1} \cdot [ {( {x}_{p} - ( {i}_{A} \cdot {d}_{x} ) )}^{2} + {( {j}_{A} \cdot {d}_{z} )}^{2} ]}}{c} ,$$
wherein ε₁ is a relative dielectric constant of a frozen soil area, dₓ is a pixel width, d_{z} is a pixel height, c is a propagation speed of light in vacuum, i_{A} is an abscissa of the pixel A, and j_{A} is an ordinate of the pixel A,
a response amplitude RA_{A,P} corresponding to each pixel is expressed as follows:
$$R {A}_{A , p} = {s}_{p} ( t = {τ}_{A , p} ) ,$$
wherein Sₚ is a reflected electromagnetic wave recorded by the GPR moving to the p^{th} channel signal,
the response of each imaging point in the signal is distributed in n groups of A-scan data generated by GPR measurement, and corresponding to the pixel A, there are n groups of response amplitudes, and a vector combination is an imaging output result, which is expressed as follows:
$${E}_{A} = {\sum }_{k = 1}^{n} R {A}_{A , k} .$$

8. A processing device, comprising a processor and a memory, wherein the memory stores a computer program, and the processor executes the method according to claim 6 when calling the computer program in the memory.

9. A computer-readable storage medium, wherein the computer-readable storage medium stores a plurality of instructions, the instructions suitable for being loaded by a processor to execute the method according to claim 6.
